(19) United States
(12) Patent Application Publication
(10) Pub. No.: US 2025/0229822 A1
(43) Pub. Date: Jul. 17, 2025

(54) HAULER DEVICE

(71) Applicant: Anne Cook, Las Vegas, NV (US)

(72) Inventor: Anne Cook, Las Vegas, NV (US)

(21) Appl. No.: 19/028,955

(22) Filed: Jan. 17, 2025

Related U.S. Application Data
(60) Provisional application No. 63/621,680, filed on Jan. 17, 2024.

(51) Int. Cl. B62B 13/16; B62B 13/18; B62B 17/06

(52) U.S. Cl. CPC B62B 13/16; B62B 13/18; B62B 17/061

(57) ABSTRACT

A hauler device is disclosed for transporting multiple items across the floor or upstairs with ease. The device is a hard plastic sled equipped with a long, rope-type or flexible handle to pull the sled across the ground or upstairs. The hauler device comprises a body component that is configured in a rectangular (i.e., rectilinear) shape as a sled. The body component is capable of holding multiple items to be transported across the floor or upstairs, such as groceries, retail items, etc. Attached to the body component is a long, cord-type or flexible handle used to pull the sled. Thus, once the body component of the device is loaded with items, a user can transport the items by pulling the handle of the sled in a convenient and less physically taxing manner.

### CROSS-REFERENCE TO RELATED APPLICATION

The present application claims priority to, and the benefit of, U.S. Provisional Application No. 63/621,680, which was filed on Jan. 17, 2024, and is incorporated herein by reference in its entirety.

### FIELD OF THE INVENTION

The present invention relates generally to the field of item transporting devices. More specifically, the present invention relates to a sled-like device that assists in transporting items up one or multiple flights of stairs. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in item transporting devices. Generally, hauling groceries and other items upstairs can present various difficulties and challenges. Carrying heavy bags or items up one or multiple flights of stairs can put significant strain on the muscles, particularly the back, shoulders, and legs. This strain may lead to fatigue, discomfort, or even injury, especially if proper lifting techniques are not used. Additionally, carrying large or numerous items upstairs can obstruct a person's line of sight, making it difficult to see where he or she is stepping. This increases the risk of tripping or stumbling, especially if the stairs are poorly lit. Depending on the volume of groceries or items, multiple trips up and down the stairs may be necessary. This not only adds to the time required but also increases the physical exertion.

Accordingly, there is a demand for an improved hauler device that holds multiple items to be transported upstairs. More particularly, there is a demand for a hauler device that transports items or groceries upstairs in a safe and strain-free fashion.

Therefore, there exists a long-felt need in the art for a hauler device that provides users with a hard plastic sled equipped with a long, rope-type or flexible handle to pull the sled across the ground. There is also a long-felt need in the art for a hauler device that enables users to fill the sled with different items like groceries or retail items and easily transport them up one or multiple sets of stairs. Further, there is a long-felt need in the art for a hauler device that includes optional wheels that can be secured on the sled base to facilitate movement across indoor or outdoor ground surfaces. Moreover, there is a long-felt need in the art for a device that allows users to collapse the sled when not in use for easier storage and transportation. Finally, there is a long-felt need in the art for a hauler device that reduces physical strength and dexterity needed to carry any type of item across the floor or up the stairs.

The subject matter disclosed and claimed herein, in one embodiment thereof, comprises a hauler device for transporting items or groceries across the ground or upstairs with ease. The device is a hard plastic sled equipped with a long, rope-type or flexible handle to pull the sled across the ground or upstairs. The hauler device comprises a body component that is configured in a rectangular (i.e., rectilinear) shape as a sled. The body component is capable of holding multiple items to be transported across the floor or upstairs, such as groceries, retail items, etc. Attached to the body component is a long, tope-type handle used to pull the sled. Thus, once the body component of the device is loaded with items, a user can transport the items by pulling the handle of the sled in a convenient and less physically taxing manner. Accordingly, the device helps reduce trips and falls while trying to transport multiple items upstairs and prevents unnecessary strain on the body.

In this manner, the hauler device of the present invention accomplishes all of the forgoing objectives and provides users with a device that allows for easier transportation of groceries or other items upstairs. The device is a body component that can hold multiple items or groceries. The device features a long, rope-type or flexible handle.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a hauler device. The device is a sled for hauling multiple items across the floor or upstairs with ease. The hauler device comprises a body component to be filled with items and a long, rope-type or flexible handle. Thus, once the body component of the device is loaded with items, a user can transport the items by pulling the handle of the sled in a convenient and less physically taxing manner.

In one embodiment, the hauler device provides users with a sled that can be loaded with groceries or other items and pulled across the ground or up one or multiple flights of stairs. The hauler device includes optional wheels that can be secured on the sled base to facilitate movement across indoor or outdoor ground surfaces. The hauler device allows users to collapse the sled when not in use for easier storage and transportation. The device reduces physical strength and dexterity needed to carry any tope of item across the floor or upstairs.

In one embodiment, the hauler device comprises a body component. The body component is typically configured in a rectangular (i.e., rectilinear) shape but can be configured in any suitable shape as is known in the art. Generally, the body component is shaped to resemble a small sled. Typically, the body component comprises collapsible side walls, locking mechanisms, an interior volume, runners, wheels, and fasteners.

In one embodiment, the collapsible side walls of the body component are designed to further support items loaded into the interior volume of the body component. The collapsible side walls can be collapsed inward and held in place by locking mechanisms when the hauler device is not in use. This allows for easier storage and transportation.

In one embodiment, optional wheels and runners can be attached to the bottom surface of the body component with fasteners. The wheels and runners allow optimal movement performance over a variety of surfaces.

In one embodiment, the hauler device comprises a handle that is pulled to haul items loaded in the device. Typically, the handle is a rope-type or flexible handle, although any suitable handle as is known in the art may be used. In one embodiment, the handle features a hand cushion over the section the user holds to provide comfort and a better grip. Typically, the hand cushion is manufactured of foam although any suitable material may be used.

In one embodiment, the hauler device in accordance with the present invention can be produced in various colors, designs, patterns, etc., and feature logos, emblems and or designs, such as a distributor requests and/or a user desires.

In one embodiment, the hauler device is manufactured of a high-density polyethylene (HDPE), or any other suitable materials as is known in the art. Any number of different types of materials can be used to make the hauler device including but not limited to plastics, nylon, textile materials, etc.

In use, the user releases the locking mechanisms of the body component. Further, the user unfolds the collapsible side walls. Next, the user loads the interior volume of the body component with various items. Finally, the user may utilize the device to haul items across the floor or upstairs by pulling the device by the handle. Thus, once the body component of the device is loaded with items, a user can transport the items by pulling the handle of the sled in a convenient and less physically taxing manner

It will also be appreciated that there are a number of additional add-on features that can be incorporated into the device and moreover, the hauler device can take many different forms as is known in the art.

In yet another embodiment, the hauler device comprises a plurality of indicia.

In yet another embodiment, a method of conveniently transporting multiple items across the floor or upstairs is disclosed. The method includes the steps of providing a hauler device comprising a body component and handle. The method also comprises releasing the locking mechanisms of the body component. Further, the method comprises unfolding the collapsible side walls. Next, the method comprises loading the interior volume of the body component with various items. Finally, the method comprises utilizing the device to haul items across the floor or upstairs by pulling the handle.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the hauler device of the present invention showing the device and how it can be filled with items in accordance with the disclosed architecture;

FIG. 2 illustrates a standalone perspective view of one embodiment of the hauler device of the present invention and its components in accordance with the disclosed architecture;

FIG. 3 illustrates a perspective view of one embodiment of the hauler device of the present invention showing how the device can fold flat for easier transportation and storage in accordance with the disclosed architecture;

FIG. 4 illustrates a perspective view of one embodiment of the hauler device of the present invention showing the device being pulled up a set of stairs while filled with items in accordance with the disclosed architecture;

FIG. 5 illustrates a perspective view of another embodiment of the hauler device of the present invention showing how wheels can be attached to facilitate movement across different surfaces in accordance with the disclosed architecture; and

FIG. 6 illustrates a flowchart showing the method of conveniently transporting multiple items across the floor or upstairs in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a hauler device that provides users with a hard plastic sled equipped with a long, rope-type or flexible handle to pull the sled across the ground. There is also a long-felt need in the art for a hauler device that enables users to fill the sled with different items like groceries or retail items and easily transport them up one or multiple sets of stairs. Further, there is a long-felt need in the art for a hauler device that includes optional wheels that can be secured on the sled base to facilitate movement across indoor or outdoor ground surfaces. Moreover, there is a long-felt need in the art for a device that allows users to collapse the sled when not in use for easier storage and transportation. Finally, there is a long-felt need in the art for a hauler device that reduces physical strength and dexterity needed to carry any type of item across the floor or up the stairs.

The present invention, in one exemplary embodiment, is a novel hauler device for hauling a variety of items such as groceries or retail items across the ground or upstairs. The hauler device comprises a body component that is configured in a rectangular (i.e., rectilinear) or sled-like shape. The body component comprises an interior volume within which items can be loaded. The device also comprises a handle attached to the body component to pull the device along the ground or upstairs. The device also comprises optional runners and wheels to be removably attached to the underside of the body component to facilitate movement over a variety of surfaces. Thus, once the body component of the device is loaded with items, a user can transport the items by pulling the handle of the sled in a convenient and less physically taxing manner. The present invention also includes a novel method of conveniently transporting multiple items across the floor or upstairs. The method includes the steps of providing a hauler device comprising a body component and handle. The method also comprises releasing the locking mechanisms of the body component. Further, the method comprises unfolding the collapsible side walls. Next, the method comprises loading the interior volume of the body component with various items. Finally, the method comprises utilizing the device to haul items across the floor or upstairs by pulling the handle.

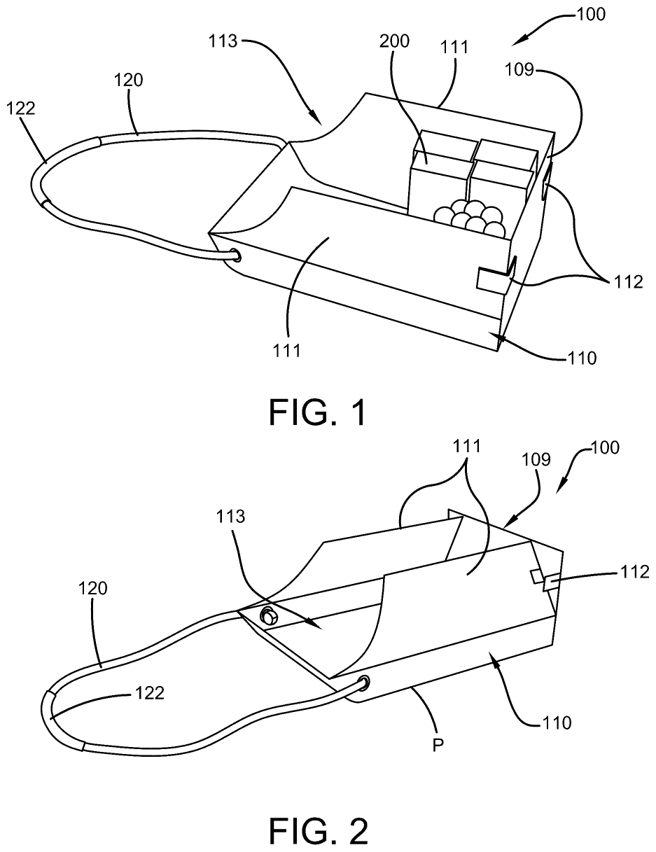

Referring initially to the drawings, FIG. 1 illustrates a perspective view of one embodiment of the hauler device 100 of the present invention loaded with items 200. In the present embodiment, the hauler device 100 is an improved hauler device 100 that provides a user with a sled for transporting multiple items across the ground or up flights of stairs 250 as is shown in FIG. 4. Specifically, the hauler device 100 comprises a body component 110 with a handle 120. The body component 110 includes a rigid or semi-rigid bottom surface for supporting the load within the body component 110 and for sliding along a ground or a stair surface (i.e., step edges). Thus, once the body component 110 of the device 100 is loaded with items 200, a user can transport the items 200 by pulling the handle 120 of the device 100 in a convenient and less physically taxing manner.

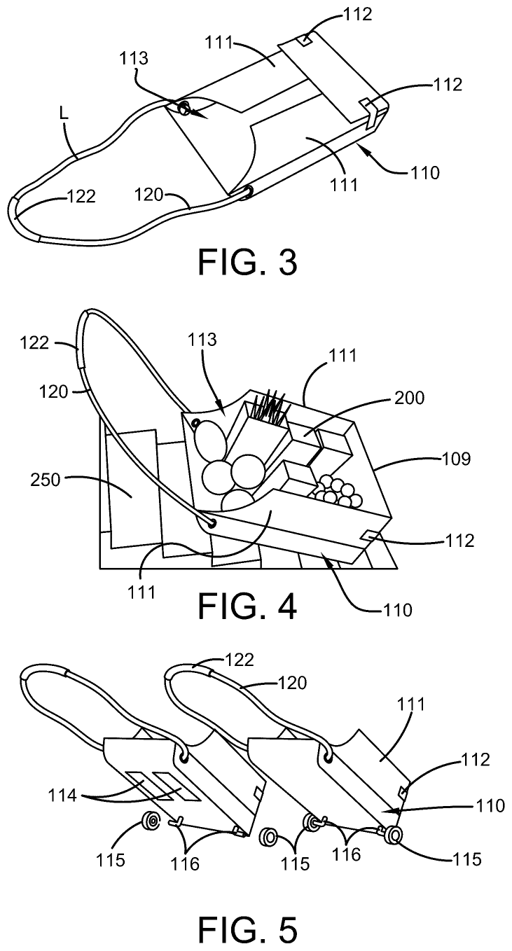

As shown in FIGS. 2 and 3, the hauler device 100 comprises a body component 110. The body component 110 is typically configured in a rectangular (i.e., rectilinear) shape but can be configured in any suitable shape as is known in the art. Generally, the body component 110 is shaped to resemble a small sled. Typically, the body component 110 comprises a selectively collapsible rear wall 109 and selectively collapsible opposing side walls 111, locking mechanisms 112, an interior volume 113, runners 114, wheels 115, and fasteners 116.

As shown in FIG. 3, the collapsible rear wall 109 and opposing side walls 111 of the body component 110 are designed to further support items 200 loaded into the interior volume 113 of the body component 110. The collapsible rear wall 109 and opposing side walls 111 can be collapsed inward and held in place by locking mechanisms 112 when the hauler device 100 is not in use. This allows for easier storage and transportation. It is to be appreciated that a height of the rear wall 109 is equal to a height of the opposing side walls 111.

As shown in FIG. 5, optional wheels 115 and runners 116 can be attached to the bottom surface of the body component 110 with fasteners 116. The wheels 115 and runners 116 allow optimal movement performance over a variety of surfaces.

As shown in FIGS. 1-5, the hauler device 100 comprises a handle 120 that is pulled to haul items 200 loaded in the device 100. Typically, the handle 120 is a rope-type (i.e., corded rope) or flexible handle 120, although any suitable handle as is known in the art may be used. In one embodiment, the handle 120 features a hand cushion or padded section 122 over a portion of the handle 120 to provide comfort and a better grip. Typically, the hand cushion 122 is manufactured of foam although any suitable material may be used. An overall length L of the handle 120 is from about 0.50 to about 2.00 times (i.e., from 0.50 P to 2.00 P) a circumferential perimeter dimension P (i.e., perimeter length) of the body component 110 to provide sufficient length in order to pull the device 100 upstairs without stooping. In another embodiment, the overall length L of the handle 120 is from about 0.75 to about 1.50 times (i.e., from 0.75 P to 1.50 P) a circumferential perimeter dimension P (i.e., perimeter length) of the body component 110.

It is to be appreciated that the hauler device 100 in accordance with the present invention can be produced in various colors, designs, patterns, etc., and feature logos, emblems and or designs, such as a distributor requests and/or a user desires.

In one embodiment, the hauler device 100 is manufactured of a high-density polyethylene (HDPE), or any other suitable materials as is known in the art. Any number of different types of materials can be used to make the hauler device 100 including but not limited to nylon, textile materials, heat-sealable plastic or polymers, such as polypropylene or acrylonitrile-butadiene-styrene (ABS), or any other suitable material as is known in the art, such as but not limited to, acrylic, polycarbonate, polyethylene, polyethylene terephthalate, polyvinyl chloride, polystyrene, etc.

In yet another embodiment, the hauler device 100 comprises a plurality of indicia 400. The body component 110 of the device 100 may include advertising, a trademark, or other letters, designs, or characters, printed, painted, stamped, or integrated into the body component 110, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be shopping or brand related.

It will also be appreciated that there are a number of additional add-on features that can be incorporated into the device 100 and moreover, the hauler device 100 can take many different forms as is known in the art.

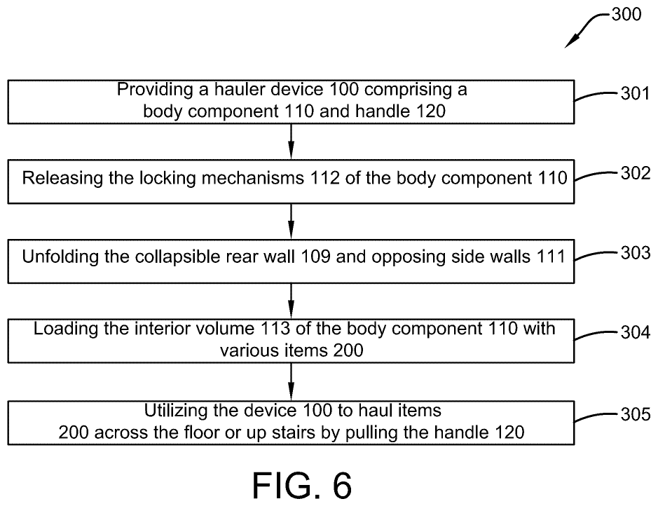

FIG. 6 illustrates a flowchart of the method 300 of conveniently transporting multiple items 200 across the floor or upstairs. The method 300 includes the steps of at 301, providing a hauler device 100 comprising a body component 110 and handle 120. The method 300 also comprises at 302, releasing the locking mechanisms 112 of the body component 110. Further, the method 300 comprises at 303, unfolding the collapsible rear wall 109 and opposing side walls 111. Next, the method 300 comprises at 304, loading the interior volume 113 of the body component 110 with various items 200. Finally, the method 300 comprises at 305, utilizing the device 100 to haul items 200 across the floor or upstairs by pulling the handle 120.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “hauler device”, “hauling device”, “sled device”, and “device” are interchangeable and refer to the hauler device 100 of the present invention.

Notwithstanding the forgoing, the hauler device 100 of the present invention can be of any suitable size and configuration as is known in the art without affecting the overall concept of the invention, provided that it accomplishes the above stated objectives. One of ordinary skill in the art will appreciate that the hauler device 100 as shown in FIGS. 1-5 is for illustrative purposes only, and that many other sizes and shapes of the hauler device 100 are well within the scope of the present disclosure. Although the dimensions of the hauler device 100 are important design parameters for user convenience, the hauler device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A hauler device comprising:
a body component; and
a handle;
wherein said body component having a selectively collapsible rear wall;
wherein said body component having a selectively collapsible pair of opposing side walls;
wherein said body component having a rigid bottom surface;
wherein said handle is flexible;
wherein said handle having a length;
wherein said body component having a perimeter length; and
further wherein said handle length is from 0.50 to 2.00 times said body component perimeter length.

2. The hauler device of claim 1, wherein said body component having a rectilinear shape.

3. The hauler device of claim 2, wherein said rigid bottom surface having a pair of runners for sliding simultaneously along front edges of at least a pair of adjacent steps.

4. The hauler device of claim 3, wherein said handle is a corded rope.

5. The hauler device of claim 4, wherein said handle having a padded section along a portion of said handle.

6. The hauler device of claim 5, wherein said handle length is from 0.75 to 1.50 times said body component perimeter length.

7. The hauler device of claim 6, wherein a height of said rear wall is equal to a height of said pair of opposing side walls.

8. The hauler device of claim 7, wherein said rigid bottom surface having a pair of wheels mounted thereto, and further wherein said pair of wheels are distal to said handle.

9. The hauler device of claim 8, wherein one of said pair of opposing side walls and said rear wall having a first fastener for securing said one of said pair of opposing side walls to said rear wall.

10. The hauler device of claim 9, wherein another of said pair of opposing side walls and said rear wall having a second fastener for securing said another of said pair of opposing side walls to said rear wall.

11. A hauler device comprising:
a body component; and
a handle;
wherein said body component having a selectively collapsible rear wall;
wherein said body component having a selectively collapsible pair of opposing side walls;
wherein said body component having a rigid bottom surface;
wherein said handle is flexible;
wherein said handle having a length;
wherein said body component having a perimeter length;
wherein said handle length is from 0.50 to 2.00 times said body component perimeter length; and
further wherein said rigid bottom surface having a pair of runners for sliding simultaneously along front edges of at least three adjacent steps.

12. The hauler device of claim 11, wherein said body component having a rectilinear shape.

13. The hauler device of claim 11, wherein said handle is a corded rope.

14. The hauler device of claim 11, wherein said handle having a padded section along a portion of said handle.

15. The hauler device of claim 11, wherein said handle length is from 0.75 to 1.50 times said body component perimeter length.

16. The hauler device of claim 11, wherein a height of said rear wall is equal to a height of said pair of opposing side walls.

17. The hauler device of claim 11, wherein said rigid bottom surface having a pair of wheels mounted thereto, and further wherein said pair of wheels are distal to said handle.

18. The hauler device of claim 11, wherein one of said pair of opposing side walls and said rear wall having a first fastener for securing said one of said pair of opposing side walls to said rear wall.

19. The hauler device of claim 18, wherein another of said pair of opposing side walls and said rear wall having a second fastener for securing said another of said pair of opposing side walls to said rear wall.

20. A hauler device comprising:
a body component; and
a handle;
wherein said body component having a selectively collapsible rear wall;
wherein said body component having a selectively collapsible pair of opposing side walls;
wherein said body component having a semi-rigid bottom surface;
wherein said handle is flexible;
wherein said handle having a length;
wherein said body component having a perimeter length;
wherein said handle length is from 0.50 to 2.00 times said body component perimeter length;
wherein said semi-rigid bottom surface having a pair of runners for sliding simultaneously along front edges of at least three adjacent steps;
further wherein said semi-rigid bottom surface having a pair of wheels mounted thereto; and
further wherein said pair of wheels are distal to said handle.
